(19) United States
(12) Patent Application Publication
(10) Pub. No.: US 2009/0007396 A1
(43) Pub. Date: Jan. 8, 2009

(54) Holder assembly for currency, credit cards and like objects

(76) Inventor: Adam Glickfield, Miami Beach, FL (US)

Correspondence Address: MALLOY & MALLOY, 2800 S.W. THIRD AVENUE, HISTORIC CORAL WAY, MIAMI, FL, 33129, US

(21) Appl. No.: 12/154,444

(22) Filed: May 22, 2008

Related U.S. Application Data
(63) Continuation-in-part of application No. 11/416,965, filed on May 3, 2006, now abandoned.

(51) Int. Cl. B65D 63/00; G09F 11/00

(52) U.S. Cl. 24/17 A; 24/17 B; 40/1

(57) ABSTRACT

A holder assembly for paper currency, credit cards and other type of currency including an elongated band comprising a plurality of movably interconnected segments extending along a length thereof. A connecting assembly interconnects the plurality of segments and is structured to facilitate expansion or contraction of the band as well as to normally bias the band, as well as the plurality of segments, into a contracted orientation. In at least one embodiment a coupling assembly is connected to the band and is disposed and structured to vary the length of the band such that the longitudinal dimension thereof is adjustable whether the band is in the expanded or contracted orientation. In addition, a plurality of grip members facilitates retaining of the currency held by the holder assembly.

### CLAIM OF PRIORITY

The present application is a continuation-in-part application of previously filed, now pending application having Ser. No. 11/416,965, filed on May 3, 2006 incorporated herein by reference.

### BACKGROUND OF THE INVENTION

1. Field of the Invention

A holder assembly comprising an elongated band formed of a plurality of segments movably interconnected and selectively disposable from a normally contracted orientation into an expanded orientation, wherein the overall size and structure of the band is such as to surround and retain paper money, other types of currency and a variety of cards including, but not limited to, credit, identification and business cards, as well as other objects.

2. Description of the Related Art

Devices specifically intended to hold and/or retain money, in particular paper currency, have been known and utilized for many years. In perhaps their most simplistic form, money holders may comprise an elastic or “rubber” band having sufficient dimension and elasticity to surround folded paper currency and the like. Besides the relatively unappealing aesthetic properties of such an elastic band type of money holder, the reliability of such structures is questionable, especially when access to the retained currency is a frequent occurrence throughout the day. Other common types of money holding devices include money clips typically formed from a single piece of relatively flexible material, such as metal, plastic or a variety of other appropriate materials. Moreover, conventional money clips have been known to be made from silver, gold or other precious metals. Also common to conventional money clips or like holders is the inclusion of numerous fanciful designs and decorative dress including decorative structure such as coins, jewels, scripted plates, etc. When using such conventional structures the currency is typically folded and placed into a gap defined by the overall structure of the flexible money clip. One frequently recognized disadvantage of known money clips is the relative small quantity of currency and/or credit cards which may be inserted within the retaining gap without permanently deforming it. Such deformation of the money clip would of course render it unreliable or at worst, useless for the express purpose of containing folded currency, in the manner described above.

Perhaps the most commonly recognized advantage of money clips and other types of money holders is the ability to allow the user to carry the retained currency in a relatively small area such as the pants or jacket pockets or other conveniently small but readily accessible areas. Such convenient dimensioning of known money holders overcomes disadvantages and problems associated with carrying money, credit cards and like currency in wallets, pocketbooks, purses, etc. While wallets or pocketbooks are still in common use, the ability to easily and quickly access folded currency and/or credit cards contained therein becomes problematic.

While money clips and other types of holders, of the type set forth, above are no longer as popular as in years past, the decreased use of such structures may possibly be attributable directly to the increased use of credit cards. The growth in the use of credit cards and other types of card structures, such as ATM cards, smart cards, etc, has resulted in the need for a means of conveniently and securely carrying one or more of such cards on the person of an individual. Further, the popularity of money clips is more specifically attributable to the fact that both currency and a plurality of credit cards can not be effectively and/or reliably retained by conventional money clips of the types described above. In addition, while money clips may have been considered a convenient and efficient way to retain paper currency, they are not as effective for the purpose in carrying credit cards, driver licenses of other identification cards of the type set forth above.

Currently, as well as in the near future, electronic or “smart” card technology will advance to the point where the amount of paper currency an individual usually carries may be significantly reduced. However, it is believed that an improved currency holder assembly would still be desired, as long as it overcomes the problems of the type set forth above. Therefore, there is a growing and significant need for an effective and efficient holder assembly structured to retain currency in the form of paper currency, credit cards, smart cards, ATM cards as well as identification cards such as a driver license and the like. Further, such a proposed currency holder assembly should have the structural and operative versatility to accommodate currency and/or credit cards of an increased size, thereby enabling a user to carry a plurality of such credit and/or identification cards currently with paper currency in an efficient and effective manner. Also, the structural reliability of a proposed and preferred currency holder assembly should be assured by forming it from a durable material, such as metal or a variety of other materials. Finally, a proposed holder assembly should also demonstrate sufficient versatility to be highly decorative and/or aesthetically pleasing in that the material of the components from which it is formed may be either expensive or inexpensive and may be produced to include highly decorative features or other adornments similar to but distinguishable from the aforementioned money clips structures.

### SUMMARY OF THE INVENTION

The present invention is directed to a holder assembly for paper currency, credit cards and other types of currency as well as various types of identification cards, transaction cards or like purpose cards similar in structure, configuration and dimension to conventional credit cards. Accordingly, as used herein the term “currency” is meant to be broadly interpreted and include, but not be limited to, paper money, credit cards and other commonly negotiable instruments, as well as cards or like devices which are not directly associated with the conducting of a financial transaction.

More specifically, the holder assembly comprises an elongated band which may assume a closed, continuous configuration and be otherwise structured to surround and thereby retain the currency and/or credit cards. Such an operative, retaining position of the band is facilitated by the band being structured from a plurality of movably interconnected segments. Depending upon the specific preferred embodiments utilized, the interconnected segments may extend along at least a portion or substantially the entire length of the band.

Further, a connecting assembly is cooperatively disposed and structured to movably interconnect the plurality of segments, such that adjacent ones of the segments are movable relative to one another. This movable interconnection of the plurality of segments allows the band to be selectively disposed in either an expanded orientation or a contracted orientation. As should be apparent when in the expanded orientation, at least some of the plurality of segments are disposed in a spaced relation to one another. In contrast, the contracted orientation of the plurality of segments has them disposed in a more closely adjacent relation to one another. The contracted orientation may be further defined by the plurality of segments having their longitudinal edges or sides confronting the longitudinal edges or sides of the next adjacent segments along some or all of the length of the band.

It should be apparent that when in the expanded position, the overall size of the band, such as when it assumes its normally continuous, closed configuration, is enlarged to accommodate the surrounding, retaining engagement with currency having greater bulk or dimension. When in the contracted orientation, the overall dimension of the band is reduced so as to provide a snug, close fitting, surrounding engagement of the retained currency. Accordingly, the connecting assembly is cooperatively structured with the plurality of movable interconnected segments so as to normally bias the band into the contracted orientation. Therefore, when the band is first or repeatedly applied in its operative, surrounding relation to the currency being retained, it is purposely enlarged into its expanded orientation. In so doing, the band is efficiently positioned about the currency in retaining relation thereto. Thereafter, the normal biasing of the plurality of movably interconnected segments into the contracted orientation will serve to automatically reduce the size of the band, typically to the size of the currency being retained, such that a snug, retaining engagement of the band relative to the currency is established.

It is emphasized that the connecting assembly may comprise a variety of different structures each of which are operative to movably interconnect the plurality of segments. Further, such movable interconnection, thus enable the ability of the plurality of segments to be selectively movable relative to one another in terms of separation such that disposition of the band between the expanded orientation and the contracted orientation may be easily and quickly accomplished. However, regardless of the specific embodiment of the connecting assembly, its structural and operative features should be such as to accomplish a normal biasing of the band into the aforementioned contracted orientation so as to automatically establish the intended surrounding, retaining engagement of the band about the paper money, credit cards and other types of currency, identification cards or like objects being retained by the band of the holder assembly.

At least one preferred embodiment of the holder assembly of the present invention further comprises a coupling assembly connected to the band. Moreover the structure of the coupling assembly should be such as to allow a variance in the overall length of the band. Moreover, the closed configuration assumed by the band may be increased or otherwise adjusted to accommodate retention of different quantities and/or sizes of currency, credit cards, etc. As such, the coupling assembly may assume a buckle, snap plate or other appropriate type of closure structured to facilitate adjustment of the overall length of the band. Such an adjustment may include an increase or decrease in the length thereof, when the coupling assembly is selectively disposed in a first operative position or in a second operative position. Therefore, appropriate manipulation of the coupling assembly will facilitate adjustment of the length of the band whether in its expanded orientation or its contracted orientation.

An additional feature incorporated into at least one preferred embodiment of the present invention is the provision of a display structure more specifically defined by a display field having an exposed surface. The display field may be connected along the length of the band or alternatively may be connected to or otherwise associated with the coupling assembly in its various structural and operative forms. Regardless of the location or specific structural features of the display field, the included exposed surface may be disposed and structured to incorporate any of a variety of different, predetermined indicia thereon. Such indicia may include, but not limited to, a variety of artistic and/or decorative elements, logos, trade names, individual names or initials, as well as any type of personal message or the like.

The holder assembly additionally includes at least one grip member disposed at least partially on the interior of the band and structured to facilitate retaining of the currency. Moreover, in at least one embodiment, the holder assembly comprises a plurality of grip members. As such, the grip members can be arranged in any variety of patterns and/or configurations. For example, in one embodiment, two rectangular grip members are disposed in spaced relation to one another on the interior of each segment of the band.

In addition, the grip members may comprise a gripping material of construction which provides an amount of grip such that contact with the currency will reduce or prevent slippage of the currency when the holder assembly is operatively positioned in surrounding, retaining relation to the currency. The surface of the grip members can also be textured to provide additional grip.

These and other objects, features and advantages of the present invention will become clearer when the drawings as well as the detailed description are taken into consideration.

### BRIEF DESCRIPTION OF THE DRAWINGS

For a fuller understanding of the nature of the present invention, reference should be had to the following detailed description taken in connection with the accompanying drawings in which:

FIG. 1 is a perspective view of the holder assembly of the present invention in an operative position surrounding and retaining various forms of currency.

FIG. 2 is a perspective view of the holder assembly of the embodiment of FIG. 1 disposed out of its operative position in retaining relation to currency but in a contracted orientation.

FIG. 3 is a front view in partial cutaway representing the holder assembly of the present invention in an expanded orientation.

FIG. 4 is a front perspective view in partial cutaway including a coupling assembly and associated display structure and display field exposed exteriorly of the holder assembly.

FIG. 5 is an interior perspective view of the embodiment of FIG. 4.

FIG. 6 is a perspective view of another embodiment of the coupling assembly.

FIG. 7 is a side view of still another embodiment of the coupling assembly.

FIG. 8 is a front perspective view of one embodiment of the holder assembly having a plurality of grip members.

FIG. 9 is a front view in partial cutaway representing the holder assembly of FIG. 8 in an expanded orientation.

FIG. 10 is a front perspective view of another embodiment of the holder assembly having a plurality of grip members.

FIG. 11 is a front view in partial cutaway representing the holder assembly of FIG. 10 in an expanded orientation.

Like reference numerals refer to like parts throughout the several views of the drawings.

### DETAILED DESCRIPTION OF THE PREFERRED EMBODIMENT

As represented in the accompanying drawings, the present invention is directed to a holder assembly generally indicated as 10 for paper money, credit cards, other forms of currency, identification cards and the like all generally indicated as 20. Accordingly, as used herein the term “currency” is meant to be broadly interpreted and include, but not be limited to, paper money, credit cards, smart cards as well as other types of cards and commonly negotiable instruments.

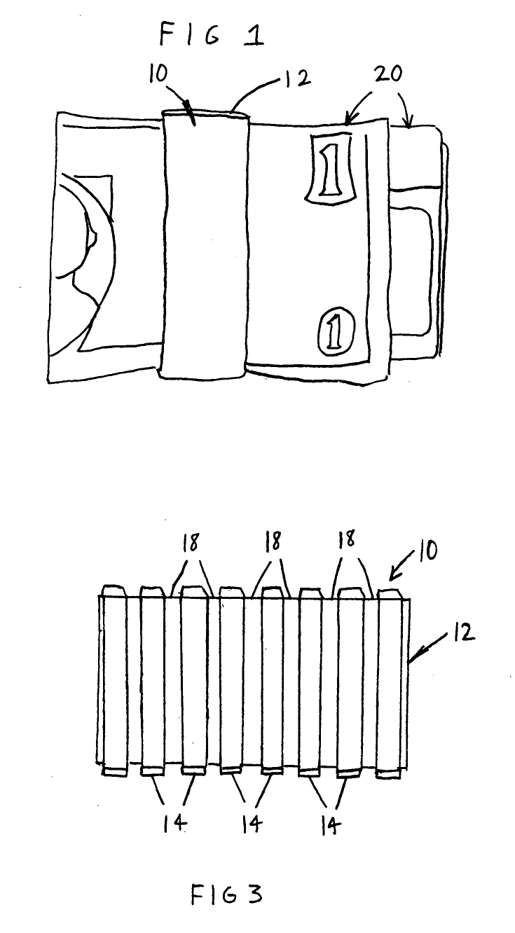

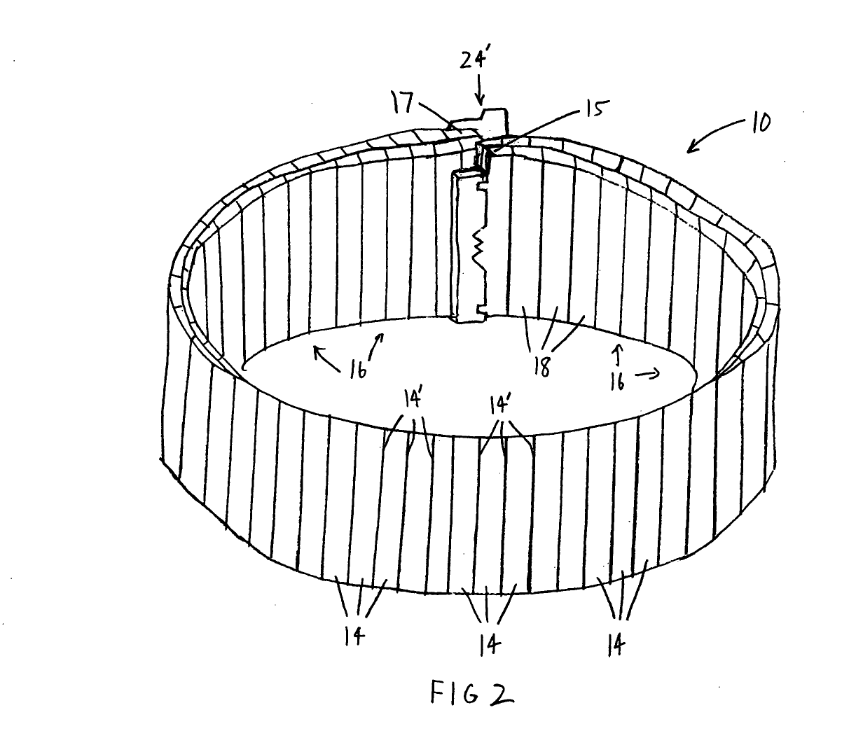

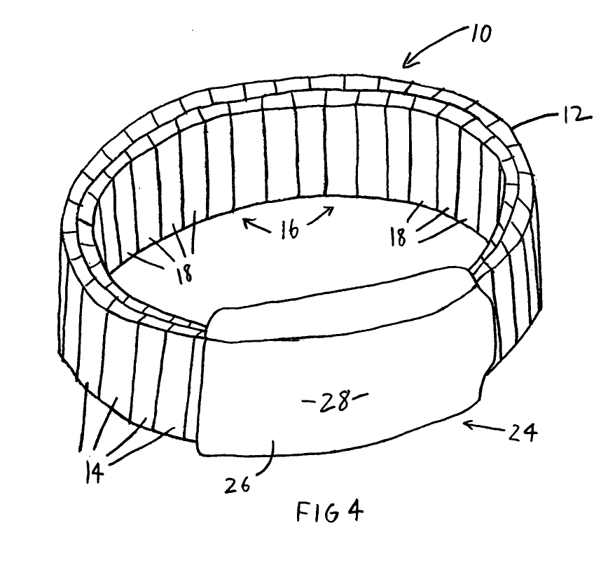

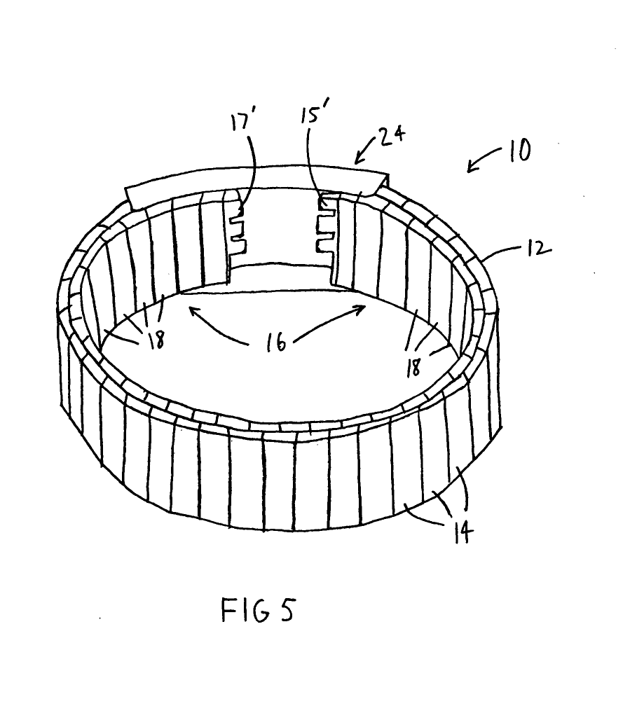

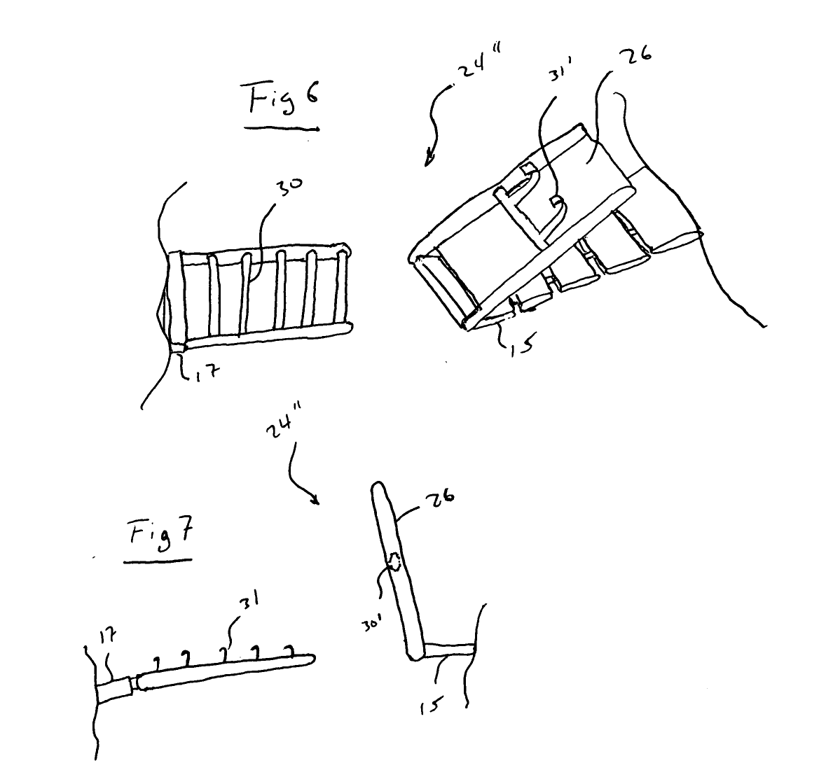

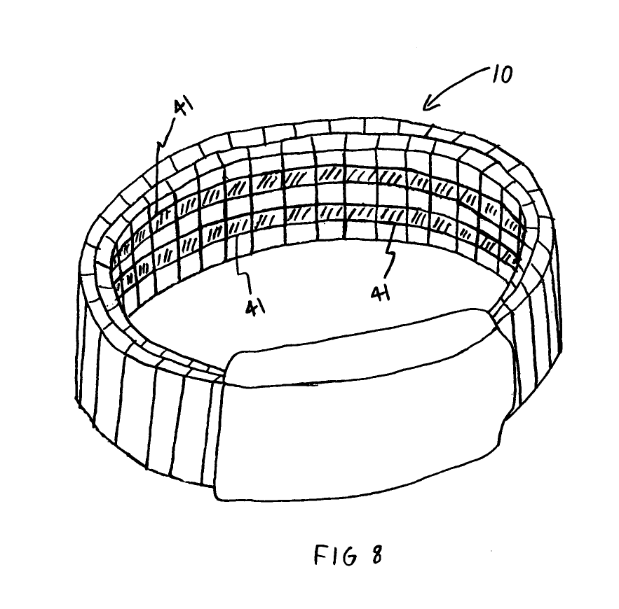

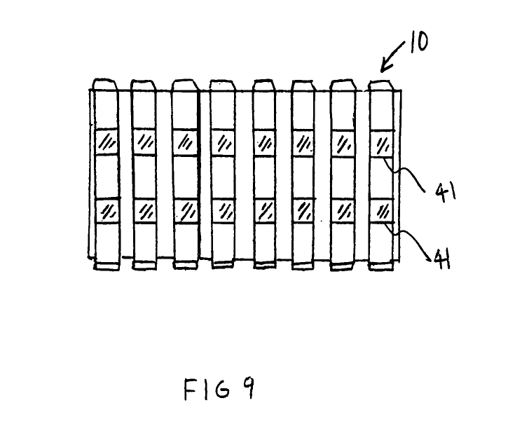

More specifically, the holder assembly 10 comprises an elongated band 12 which includes or is at least partially defined by a plurality of segments 14 extending along a majority or in some preferred embodiments along substantially the entire length of the band 12. In addition, the plurality of segments 14 are movably interconnected by a connecting assembly generally indicated as 16 and comprising a plurality of connecting links or like structures 18. The connecting assembly 16 serves to selectively and movably interconnect the plurality of segments 14 in a manner which facilitates movement of each segment 14 relative to the next adjacent segment 14 as should be apparent from a review of FIGS. 4 and 6. Accordingly, the connecting assembly 16 and in particular the plurality of connecting links 18 are cooperatively structured with the plurality of movable segments 14 so as to allow movement of the plurality of segments 14 relative to one another and specifically relative to the next adjacent segments 14. As such, the band 12 is selectively disposable between an expanded position as represented in FIG. 3 and a contracted position as represented in FIGS. 2, 4 and 5. Further, the cooperative structuring between the connecting assembly 16, including the plurality of connecting links 18, and the plurality of segments 14 is such as to normally bias a plurality of segments 14 along at least a portion of the band 12 into the contracted orientation, such as represented in FIGS. 1, 2, 4 and 5.

When it is desired to enlarge the band 12 into the expanded orientation, some or all of the plurality of segments 14 may be spaced apart in at least partially separated relation to one another. Alternatively at least some of the segments 14 may be separated as demonstrated in FIG. 3 while others of the plurality of segments 14 of band 12 may still in a be substantially contracted orientation. Accordingly, when in the contracted orientation some or all of the plurality of segments 14 may be more specifically described as having their longitudinal sides or edges 14′ disposed in engagement with one another, or at least immediately adjacent and/or confronting relation to one another as clearly demonstrated in FIGS. 2, 3 and 5. Therefore, while some of the plurality of segments 14 may be separated into the preferred expanded orientation, others of the plurality of segments 14 may be concurrently disposed in the contracted orientation. The degree of expansion or contraction is therefore determined by the user of the holder assembly 10, when it is disposed about or otherwise operatively positioned in surrounding, retaining relation to the currency 20.

Yet another feature of at least one preferred embodiment of the present invention is the provision of a coupling assembly generally indicated as 24, 24′ and 24″. The coupling assembly 24, 24′ and 24″ are in the form of a buckle, fold over snap plate structure or any of a variety of appropriate coupling structures or devices. However, common to any of the possible embodiments of the coupling assembly is the ability to adjust the overall length of the band 12 such that the longitudinal dimension thereof, whether in the contracted or expanded orientation, may be increased or otherwise varied. Such an intended change in the longitudinal dimension of the band 12 facilitates the positioning of the band 12 in its operative, surrounding and retaining relation to currency 20, regardless of the bulk or overall size of the currency 20. This ability lends significantly greater versatility to the holder assembly 10 which is typically not available in money clips or other money holders of the type conventionally known.

Further, the coupling assembly 24′ and 24″, in at least one embodiment, may be secured to opposite free ends of the band 12 as at 15 and 17. Therefore, the free ends 15 and 17 in at least one preferred embodiment of the present invention, such as represented in FIGS. 2, 6 and 7 may be removably connected to one another such that the band 12 would not be disposed in a closed, continuous configuration. Of course, the coupling assembly 24 can be located at various portions along the length of the band 12 and may be fixedly connected to the band portions 15′ and 17′. By way of example, the coupling assembly 24 can be located at any point along the length of the band 12. When so positioned, the coupling assembly 24 is cooperatively structured with the plurality of segments 14 as well as the connecting assembly 16 to facilitate adjusting the length of the band 12. Moreover, a user of the coupling assembly 24 and/or 24′ may increase the overall length of the band 12 when such is necessary to operatively position the band 12 in surrounding relation to an increased quantity of currency 20.

With primary reference to FIGS. 4 and 5, yet another embodiment of the present invention comprises the coupling assembly 24 having a display field generally indicated as 26 connected thereto. The display field 26 and more specifically an outer exposed surface 28 is disposed on an outer or exterior portion of the band 12 such that it may readily observed. Further, the display field 26 and in particular the exterior or exposed surface 28 may be structured to include predetermined indicia. Such indicia may vary significantly in content and include various artistic and/or decorative elements, as well as logos, trade names, personal identification or initials, messages, inscriptions, etc. Accordingly, in the embodiment of FIG. 4 the coupling assembly 24 is primarily located on the exterior of the band 12 to facilitate viewing of the exposed surface 28 of the display field 26. However, in the embodiment of FIG. 2, the coupling assembly 24′ is at least partially or primarily disposed in an unexposed position on the interior of the band 12. When the coupling assembly 24′ is relatively positioned in an unexposed position as demonstrated in FIG. 2, the display field 26 and exposed surface may be located on the band 12 other than in direct association with the coupling assembly 24.

Therefore, the various preferred embodiments of the currency holder assembly 10 of the present invention overcomes many of the disadvantages and problems associated with money holders, money clips and like structures which are conventionally known and structured. Further, the currency holder assembly 10 of the present invention may be highly decorative by having at least the plurality of segments 14 formed a variety of different materials including precious and non-precious metals, plastic, various composite or other types of synthetic materials and may also include additional decorative ornamentation which may be placed at various locations along the band 12 and/or on or in direct association with the display field 26, and/or the outer, exposed surface 28, associated therewith. However, the versatility of the currency holder assembly 10 is such that the material from which the plurality of segments 14, the connecting assembly 16 and/or the coupling assembly 24 are formed may be relatively inexpensive yet sufficiently durable to provide a long operable life of the currency holder assembly 10.

Looking specifically to the embodiments of FIGS. 6 and 7, a hook and bar adjustable clasp mechanism can be employed as the coupling assembly 24″. For example, one of the free ends 17 may include a series of retaining bars 30, as in FIG. 6, or a series of hook elements 31 as in FIG. 7, disposed at spaced intervals to define different fastening positions, and conversely concealed at an underside of the display field 26 may be corresponding mating structure such as hook element 31′ illustrated in FIG. 6, or the retaining bar 30′ illustrated in FIG. 7. In this manner the currency holder assembly can be effectively closed into an operative orientation, however the tightness of that closure around the articles to be secured can be easily varied to correspond to the thickness of those articles to be secured. This provides a significant advantage over more complex adjustment structures that are not intended to be varied on a routine basis. Further, it bears note that the embodiments of FIGS. 6 and 7 are intended to be illustrative, it being understood that if desired the multiple fastening points can be maintained beneath the display field 26 instead of at free end 17 as illustrated. Moreover, a variety of other easily adjustable clasp mechanisms can be employed wherein a series of fastening points are provided for selective securement by a user in response to the demands of the articles to be held.

Turning now to the embodiment of FIGS. 8-11, the holder assembly 10 comprises at least one grip member 41 disposed at least partially on an interior of the band 12 and structured to facilitate retaining of the currency 20.

With particular reference to the embodiment of FIG. 8, the holder assembly 10 comprises a plurality of grip members 41 arranged along the interior of the band 12. More specifically, two grip members 41 are disposed in spaced relation to one another on the interior of each segment 14 of the band 12. In this embodiment, the grip members 41 appear to form two strips when the band 12 is in disposed in the contracted orientation. However, as further seen in FIG. 9, when the band 12 is disposed in the expanded orientation, the separation of the segments 14 reveals the individual grip members 41 disposed on each segment 14.

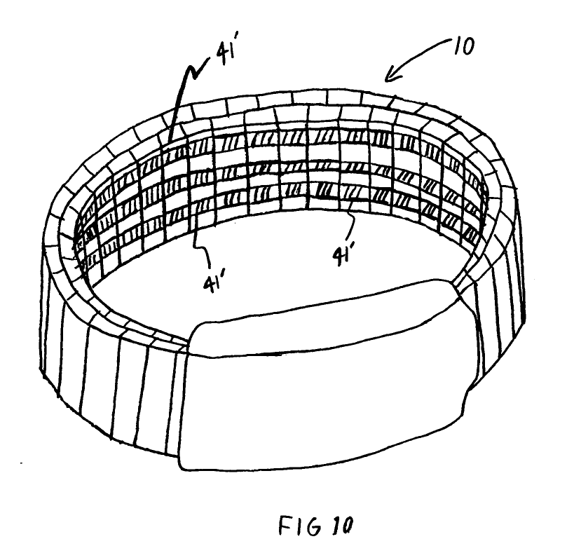

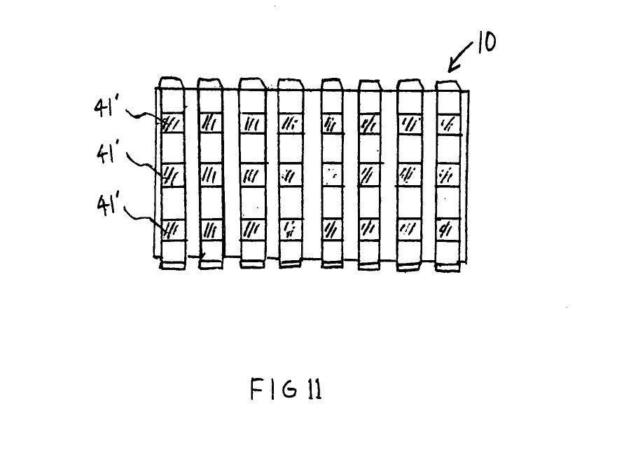

Similarly, as seen in FIGS. 10-11, the holder assembly 10 comprises a plurality of grip members 41′ arranged along the interior of the band 12. In this embodiment, three grip members 41′ are disposed in spaced relation to one another on the interior of each segment 14 of the band 12.

In addition to the embodiments depicted in FIGS. 8-11, the plurality of grip members 41 can be arranged in any variety of patterns and/or configurations. For example, the grip members 41 may be used on only one or only some of the segments 14, such as every other segment 14 or every few segments 14. As another example, different segments 14 may comprise different numbers of grip members 41. In still another embodiment, each grip member 41 substantially covers the entire inner surface of a segment 14. In yet another embodiment, the individual grip members 41 are dimensioned and configured so as to appear distinct from one another even when the band 12 is disposed in the contracted orientation.

It should also be noted that although the grip members 41, 41′ of FIGS. 8-11 each comprise rectangular configurations, it is within the scope and intent of the present invention that other configurations may be utilized for each individual grip member, such as, but not limited to, geometric shapes, letters, designs, logos, etc.

In at least one embodiment, the grip members 41 comprise a gripping material of construction which provides an amount of grip such that contact with the currency 20 will reduce or prevent slippage of the currency 20 when the holder assembly 10 is operatively positioned in surrounding, retaining relation to the currency 20. As such, a variety of different materials including various composite or other types of synthetic materials can be utilized as a gripping material of construction. For example, in at least one embodiment, at least one grip member comprises a rubber material of construction. In another embodiment, the gripping material of construction possesses a degree of tackiness or stickiness which facilitates retaining of the currency 20.

In a still further embodiment, the surface of at least one grip member 41 is textured to provide additional grip. For instance, the textured surface of the grip member 41 can include, but is not limited to, a roughened texture, grooves, ridges, bumps, etc. The textured surface can also include surface relief patterns such as, but not limited to, cross hatching, geometric shapes, designs, lettering, logos, etc.

The grip members 41 can be attached to the rest of the holder assembly 10 in a variety of ways. In at least one embodiment, the grip members 41 are attached to the surface of the interior of the band 12. In one such embodiment, the grip members 41 are bonded to the interior surface of the segments 14 using an adhesive. Other attachment mechanisms may also be utilized, including, but not limited to, fasteners. In another embodiment, the grip members 41 are at least partially embedded into the segments 14. Accordingly, the embedded grip members 41 can, in some embodiments, comprise a greater thickness than the surface mounted grip members 41.

Since many modifications, variations and changes in detail can be made to the described preferred embodiment of the invention, it is intended that all matters in the foregoing description and shown in the accompanying drawings be interpreted as illustrative and not in a limiting sense. Thus, the scope of the invention should be determined by the appended claims and their legal equivalents.

Now that the invention has been described,

What is claimed is:

1. A holder assembly for currency comprising:
a band having an elongated configuration and including a plurality of interconnected segments extending along the length thereof,
said plurality of segments movable relative to one another to facilitate disposition of said band between an expanded orientation and a contracted orientation,
a connecting assembly movably interconnecting adjacent ones of
said plurality of segments and structured to normally bias said plurality of segments into said contracted orientation, said plurality of segments and said connecting assembly cooperatively structured to dispose said band in surrounding, retaining relation to the currency, and
at least one grip member disposed at least partially on an interior of said band, said at least one grip member structured to facilitate retaining of the currency.

2. A holder assembly as recited in claim 1 wherein said band further comprises a closed configuration.

3. A holder assembly as recited in claim 2 wherein said plurality of segments collectively extend continuously along the length of said band.

4. A holder assembly as recited in claim 2 further comprising a coupling assembly connected to said band and structured to vary the length of said closed configuration when said band is in either said expanded or contracted orientation.

5. A holder assembly as recited in claim 4 wherein said coupling assembly is disposed and structured to partially define said closed configuration.

6. A holder assembly as recited in claim 5 wherein said coupling assembly is primarily disposed on said interior of said band in a primarily unexposed position.

7. A holder assembly as recited in claim 5 wherein said coupling assembly is primarily disposed on an exterior of said band in an exposed position.

8. A holder assembly as recited in claim 7 wherein said coupling assembly comprises a display field disposed on an outer exposed surface thereof.

9. A holder assembly as recited in claim 1 further comprising a display field connected to said band and including an outer, exposed surface disposed and structured to display predetermined indicia thereon.

10. A holder assembly as recited in claim 9 wherein said display field is disposed on an exterior of said band.

11. A holder assembly as recited in claim 1 comprising a plurality of grip members disposed at least partially on said interior of said band.

12. A holder assembly as recited in claim 11 wherein at least one of said plurality of grip members is disposed on at least one of said segments.

13. A holder assembly as recited in claim 12 wherein each of said segments includes at least one of said plurality of grip members.

14. A holder assembly as recited in claim 1 wherein said at least one grip member comprises a rubber material of construction.

15. A holder assembly for currency comprising:
a flexible band having an elongated configuration,
a plurality of interconnected segments collectively extending continuously along a length of said band,
said plurality of segments movable relative to one another to facilitate said band being disposable between an expanded orientation and a contacted orientation,
a coupling assembly connected to opposite ends of said band and structured to selectively vary the length of said band when in either said expanded or contracted orientations,
a connecting assembly movably interconnecting at least adjacent ones of said plurality of segments and structured to normally bias at least some of said plurality of segments into said contracted orientation,
said plurality of segments and said connecting assembly cooperatively structured to dispose said band in surrounding, retaining relation to the currency, and
a plurality of grip members, at least one of said plurality of grip members being disposed at least partially on an interior of said band, said plurality of grip members structured to facilitate retaining of the currency.

16. A holder assembly as recited in claim 15 wherein said coupling assembly is further structured to removably connect said opposite ends of said band.

17. A holder assembly as recited in claim 15 wherein said coupling assembly is primarily disposed on an exterior of said band in an exposed position.

18. A holder assembly as recited in claim 17 wherein said coupling assembly comprises a display field disposed on an outer exposed surface thereof.

19. A holder assembly as recited in claim 15 further comprising a display field connected to said band and including an outer, exposed surface disposed and structured to display predetermined indicia thereon.

20. A holder assembly as recited in claim 19 wherein said coupling assembly is primarily disposed on said interior of said band in a substantially unexposed position.

21. A holder assembly as recited in claim 15 wherein said coupling assembly is primarily disposed on said interior of said band in a substantially unexposed position.

22. A holder assembly as recited in claim 15 wherein at least one of said plurality of grip members is disposed on at least one of said segments.

23. A holder assembly as recited in claim 22 wherein each of said segments includes at least one of said plurality of grip members.

24. A holder assembly as recited in claim 15 wherein at least one of said plurality of grip members comprises a rubber material of construction.

25. A holder assembly for currency comprising:
an elongated band comprising a plurality of segments extending continuously along the length thereof,
a connecting assembly interconnecting said plurality of segments in movable relation to one another,
at least some of said plurality of segments concurrently movable between an expanded orientation and a contracted orientation of said band,
said connecting assembly structured to normally biased said plurality of segments into said contracted orientation of said band,
a coupling assembly connected to said band and structured to vary the length thereof when said band is in either of said expanded or contracted orientations,
said band structured to assume a closed configuration in surrounding, retaining relation to the currency, and
a plurality of grip members, at least one of said plurality of grip members being disposed at least partially on an interior of at least one of said segments, said plurality of grip members structured to facilitate retaining of the currency.

26. A holder assembly as recited in claim 26 wherein said band further comprises oppositely disposed free ends; said coupling assembly removably interconnecting said free ends to at least partially define said closed configuration.

27. A holder assembly as recited in claim 25 wherein said coupling assembly is primarily disposed on an interior of said band in a relatively unexposed position.

28. A holder assembly as recited in claim 25 wherein said coupling assembly is primarily disposed on an exterior of said band in a relatively exposed position.

29. A holder assembly as recited in claim 28 further comprising a display field disposed on said coupling assembly, said display field including an exposed surface disposed and structured to display predetermined indicia thereon.

30. A holder assembly as recited in claim 25 wherein said coupling assembly includes a plurality of fastening points so as to easily vary the length thereof.

31. A holder assembly as recited in claim 30 wherein said coupling assembly further defines a display field, said display field structured to conceal said plurality of fastening points when in a closed orientation.

32. A holder assembly as recited in claim 31 wherein said coupling assembly includes a hook element disposed on an underside of said display field, said hook element structured to engage one of a plurality of retaining bars disposed at an opposite end of said band.

33. A holder assembly as recited in claim 31 wherein said coupling assembly includes a retaining bar disposed on an underside of said display field, said retaining bar structured to engage one of a plurality of hook elements disposed at spaced intervals an opposite end of said band.

34. A holder assembly as recited in claim 25 wherein each of said segments includes at least one of said plurality of grip members.

35. A holder assembly as recited in claim 25 wherein at least one of said plurality of grip members comprises a gripping material of construction.

36. A holder assembly as recited in claim 35 wherein said gripping material of construction comprises a rubber material of construction.

37. A holder assembly as recited in claim 25 wherein at least one of said plurality of grip members comprises a textured surface.
